(19) United States
(12) Patent Application Publication
(10) Pub. No.: US 2025/0072390 A1
(43) Pub. Date: Mar. 6, 2025

(54) Livestock Head Holder with Over-Center Drop Prevention and Improved Height Adjustability

(71) Applicant: Northquip Inc., Woodlands (CA)

(72) Inventors: Stephen Arthur Langrell, Woodlands (CA); Erik William Chobotar, Woodlands (CA); Evan Thomas Upgang, Woodlands (CA); Zachary Arthur Johnson, Woodlands (CA)

(21) Appl. No.: 18/675,047

(22) Filed: May 27, 2024

(30) Foreign Application Priority Data
Aug. 28, 2023 (WO) PCT/CA2023/051135

(51) Int. Cl. A01K 1/062

(52) U.S. Cl. CPC A01K 1/062

(57) ABSTRACT

A livestock head holder for a head gate features a top holding member, a bottom holding member and an intermediate link connecting same, of which the intermediate link occupies an over-centered locking position in a fully open state of the head holder to prevent gravitational dropping of the top holding member. The head holder is infinitely adjustable in its installed height on the head gate, via use of tightenable clamps that engage through a slot between bars of a skeletal gate panel to make clamping embrace against a rear side of the head gate bars at any user-selectable heigh along the slot therebetween.

### CROSS-REFERENCE TO RELATED APPLICATIONS

This application claims foreign priority benefit under 35 U.S.C. 119 (a) of PCT Application No. PCT/CA2023/051135, filed Aug. 28, 2023, the entirety of which is incorporated herein by reference.

### FIELD OF THE INVENTION

The present invention relates generally to livestock handling equipment, and more particularly to a livestock head holder of a type useful on the head gate of a livestock squeeze chute to provide additional restraint of the animal's head for the purpose of ear-tagging, oral inspection (mouthing), etc.

### BACKGROUND

Applicant currently markets a livestock head holder of the aforementioned type, which is illustrated in FIGS. 1A and 1B. Top and bottom holding members respectively act against the top and bottom of the animal's neck to hold the animal's head in place, for example to restrain the animal's head during ear tagging, oral examination (mouthing), etc. The head holder features a frame 10 mounted to the head gate of a squeeze chute (not shown), and a linkage in which the two holding members 12, 14 are connected by an intermediate link 16 and moved via an operating lever 18.

The operating lever 18 is coupled to the bottom holding member 12 in a manner reaching outwardly beyond a first end thereof opposite a U-shaped neck-cradle 20 that is carried at an opposed working end 12B of the bottom holding member 12 to fit against the underside of the animal's neck.

FIG. 1A shows the prior art head holder apparatus in a closed state in which both holding members 12, 14 span laterally outward from the frame 10 in a common direction so that the cradle 20 of the bottom holding member resides below the top holding member 14 near the working end 14B thereof in an orientation opening upwardly theretoward. The operating lever 18 is used to transition to the apparatus to this illustrated closed state from an initially opened state, shown in FIG. 1B, in which the top and bottom holding members instead reach upward and downward from the top and bottom of the frame 10 in nearly vertical orientations. To perform the closing stroke that transitions the linkage from the open state to the closed state, the free end 18A of the operating lever 18 is pulled outwardly and downwardly from its initial position extending upward from the first end of the upright bottom holding member. This swings the bottom holding member 12 into the laterally reaching orientation of the illustrated closed state to brace the attached neck-cradle 20 against the underside of the animal's neck. During this closing stroke of the head holder, the intermediate link 16 causes the top holding member 14 to simultaneously swing down against the topside of the animal's neck, thereby firmly holding the neck in a stationary position between the holding members 14, 16 to restrain head movement of the animal.

So that exertion of force against the holding members by attempted movement by the animal will not open the head holder, a lock and release mechanism 22 imparts an anti-opening locking action to the linkage, which prohibits movement of the holding members 12, 14 away from one another in an open direction. The lock and release mechanism 22 features a shaft 24 that is pivotally connected to the frame 10 at an upper corner thereof by a respective pivot pin 24A lying parallel to the other pivot pins of the linkage. The shaft 24 hangs downwardly from its pivotal connection at a side of the frame opposite that to which the holding members 12, 14 laterally extend in the closed state of the head holder. The shaft 24 passes downwardly through a lock housing 26 carried on a mounting plate 28 that is pivotally connected to the bottom holding member 12 adjacent the first end thereof by another pivot pin 28A that lies parallel to the other pivot pins. The lock housing 26 and mounting plate 28 thus cooperatively form a lock carrier by which the locking components inside the housing are pivotally carried on the bottom holding member 12. Inside the lock housing 26, the shaft 24 passes through an opening one or more tiltable locking plates that are spring-biased into a tilted locking position by a spring coiled around a release pin. In the tilted locking position, a perimeter edge of the locking plate's opening bites against the periphery of the shaft 24 thereby locking the shaft against downward axial displacement relative to the lock housing 26 and the locking plate 28.

An actuation end of the release pin 30 resides outside the lock housing 26 at the lower end thereof. The spring normally tilts the locking plates into their locking position, but upward axial displacement of the release pin 30 into a raised position pivots the locking plates out of their tilted locking position into the release position perpendicular to the shaft 24. To cause upward driving of the spring loaded release pin 30 into its raised position, and thereby pivot the locking plates into its release position, a cam member 38 is carried on the operating lever 18 at or near a movable connection thereof to the bottom holding member 12 through pivot pin 18d. A stop mechanism is provided through cooperation of a stop tab 42 on the bottom holding member 12 with a tubular member on a rear side of the operating lever 18, which limits an available degree of permitted relative pivoting between the operating lever 18 and the bottom holding member 12 about pivot pin 18D.

A default position of the operating lever 18 in the closed state of the head holder corresponds to a relationship of non-forceful contact, or non-contacting but close adjacency, of a convex upper camming surface 38A of the cam 38 with the lower actuation end of the release pin 30. Initial lifting of the operating lever 18 at or near the free end 18A thereof tilts the free end 18A upwardly, relative to the bottom holding member 12 about the pivot pin 18D, into a raised position forcing the camming surface 38A upwardly against the lower actuation end of the release pin 30, thereby lifting the release pin 30 into a raised position forcing the locking plates into their untilted release position perpendicular to the shaft 24. With the locking action released, continued lifting of the operating lever 18 now lifts the first end of the bottom holding member 12 along with it, which lowers an opposing working end 12B of the bottom holding member 12a downwardly about pivot pin 12C and thereby performs the opening stroke of the linkage to withdraw the two holding members 12, 14 away from one another, and thereby release the animal.

During this opening stroke, the convexly curved camming surface 38A of the cam member 38 maintains the release pin 30 in its raised position holding the locking plates perpendicular to the shaft 24 to allow continued upward travel of the lock housing 26 along the shaft 24 due to the free sliding relationship between the shaft and the perpendicular locking plates. Accordingly, this allows continued lowering of the working end 12B of the bottom holding member 12, which in turn causes the working end 14B of the top holding member 14 to rise under the action of the intermediate link 16 connected between the two holding members. Full details of this prior art livestock head holder can be seen in Applicant's issued U.S. Pat. No. 10,039,262 (hereinafter, “Applicant's '262 patent”), the entirety of which is disclosed herein by reference.

Though not specifically disclosed in Applicant's '262 patent, Applicant's present commercialized implementation the patented design is mounted to a head gate in a height-adjustable fashion, through cooperation of a set of mounting bolts installed on the headgate at static elevations thereon defined by a set of predefined bolt holes in bars of the headgate. The bolts each pass through a respective upright adjustment slot in the frame 10. The adjustment slots are relatively short vertical span, offering a rather limited amount of vertical adjustment in the mounting height of the frame 10 on the headgate relative to the installed mounting bolts, achievable via loosening and retightening of such mounting bolts, without full removal of those mounting bolts and relocation thereof to a different set of bolt holes in the headgate bars, at either a higher or lower elevation thereon. Should the slot-afforded degree of height adjustability not be sufficient in a particular case of required height adjustment of the head holder, the mounting bolts must instead be fully removed from the head gate and head holder, and reinstalled in said different set of bolt holes on the head gate. The overall height adjustability is thus dictated by the specifically selected quantity, and relative elevations, of predefined bolt holes in the headgate, and the vertical lengths of the adjustment slots in the frame 10 of the head holder.

In addition to this limitation on the height adjustability, another discovered shortcoming of Applicant's earlier design is a potential tendency for the top holding member 14 to creep downward, under gravitational influence, from its fully raised position in the fully open state of the head holder, particularly in scenarios where a nut and spring washer combination installed on the pivot pin 14C has loosened over time, and no longer provides sufficient frictional force on the raised top holding member 14 to prevent such gravitational drop from occurring. This requires periodic inspection and maintenance by the user to prevent such creeping gravitational drop of the top holding member.

Accordingly, there is a need for an improved head holder to address these shortcomings of the prior art.

### SUMMARY OF THE INVENTION

According to a first aspect of the invention, there is provided a livestock head holder comprising:
a frame;
a linkage comprising:
   a top holding member pivotally coupled to the frame at a first pivot point;
   a bottom holding member pivotally coupled to the frame at a second pivot point; and
   an intermediate link pivotally coupled to the top holding member at a third pivot point and pivotally coupled to the bottom holding member at a fourth pivot point to coordinate movement of the top and bottom holding members during opening and closing of the head holder between a closed state in which the top and bottom holding members occupy laterally oriented positions spanning in a common lateral direction from the frame to brace a top and bottom of an animal's neck, respectively, from one side thereof, and a fully open state in which the top and bottom holding members are of pivotally raised and lowered relation, respectively, to the laterally oriented positions occupied thereby in the closed state;
   wherein, relative to an imaginary reference line spanning from the second pivot point to the third pivot point, the fourth pivot point resides on a first side of said imaginary reference line in the fully open state of the head holder in an over-center position that effects an over-center locking action on the top holding member to prevent gravitational dropping thereof, and said fourth pivot point is movable, via exertion of a closing actuation force on the linkage, from said over-center position, through a center-position of coincident relation to said imaginary reference line, and onward to an opposing second side of said imaginary reference line, thereby releasing said over-center locking action.

According to a second aspect of the invention, there is provided a livestock head holder comprising:
a frame; and
a linkage comprising:
   a top holding member pivotally coupled to the frame at a first pivot point;
   a bottom holding member pivotally coupled to the frame at a second pivot point;
wherein said linkage is configured to effect an over-center locking action on the top holding member in the fully open state of the linkage to prevent gravitational dropping of said top holding member in said fully open state, and said over-center locking action is releasable by input of a closing actuation force on said linkage to initiate movement thereof toward the closed state.

Preferably the linkage further comprises an operating lever that is coupled to the bottom holding member, and actuatable to impart said closing actuation force to the linkage.

Preferably a lock and release mechanism is arranged to impart an anti-opening locking action on the linkage that prevents movement from the closed state thereof to the opening state thereof in absence of a lock-release input to said lock and release mechanism.

Preferably said operating lever is configured to provide said lock-release input to said lock and release mechanism during an initial lifting of said operating lever to initiate an opening stroke driving movement of the linkage from the closed state to the fully open state.

According to a third aspect of the invention, there is provided a livestock head holder comprising:
a frame for mounted placement against a front of a livestock head gate;
movably supported on said frame, at least one movable holding member movable between a working position spanning laterally from said frame to brace against a neck of an animal captured in said head gate, and a withdrawn position of lesser laterally protruding relation from said one side of said frame than said working position;
at least one clamp installed on said frame for clamped support thereof on said livestock head gate, each clamp comprising:
a fastener projecting from a rear of the frame to pass through an open upright slot of the head gate; and
a backing member carried on said fastener in a positioning radiating outwardly therefrom on two opposing sides thereof to brace against a rear of the livestock head gate on two opposing sides of the open slot therein;
said fastener being tightenable to draw said backing member toward the rear of the frame and thereby impart a clamping force against said rear of the livestock head gate.

Preferably said backing member has a central span radiating outwardly from the fastener, and a pair of forwardly angled bracing segments at opposing ends of said central span.

Preferably said at least one clamp comprises at least two clamps installed at elevationally spaced locations on said frame.

Preferably said elevationally spaced locations are arranged to lie on a common vertical axis in an installed position of the frame on the head gate for common penetration of a same slot in the head gate by the fasteners of said two clamps.

Preferably at least one alignment guide is provided on the rear of the frame for mating receipt thereof in the slot of the head gate during mounting of the head holder thereon to align said frame in a proper mounting orientation on the head gate.

Preferably said at least one alignment guide comprises an elongated bar running upright along the rear of the frame.

Preferably the fastener of the at least one clamp penetrates through the at least one alignment guide.

In useful combination of the head holder with a head gate, preferably said head gate comprises an adjacent pair of upright bars between which said upright slot of the headgate is delimited, and the backing member of each clamp braces against a rear of each of said two adjacent bars.

Preferably the backing member of each clamp hooks forwardly about the two adjacent bars of the livestock headgate at outer sides thereof situated oppositely of the slot between said two adjacent bars.

Preferably the head gate comprises at least one stop installed thereon to set a respective limit on a height adjustment range for the head holder within which the head holder can be slidably adjusted up and down the slot when the fastener of each clamp is loosened.

Preferably said at least one stop comprises a lower stop installed at a bottom limit of said height adjustment range.

Preferably said at least one stop comprises an upper stop installed at a top limit of said height adjustment range.

Preferably said at least one stop is installed on the front of the head gate for abutment of said at least one stop by the frame of the head holder at said respective limit on the height adjustment range.

Preferably the at least one stop includes at least one relocatable stop that is selectively mountable at each of a plurality of different selectable stop elevations on the head gate to adjust the respective limit on said height adjustment range.

Preferably the headgate comprises predefined mounting points for the relocatable stop at said plurality of different selectable stop elevations.

Preferably said predefined mounting points comprises bolt holes in the head gate for selective bolted attachment of the relocatable stop to the head gate at any of said different selectable stop elevations.

### BRIEF DESCRIPTION OF THE DRAWINGS

One preferred embodiment of the invention will now be described in conjunction with the accompanying drawings in which:

FIG. 1A is a front elevational view of prior art livestock head holder for use on a head gate of a livestock chute, and showing the head holder in a closed state in which top and bottom holding members of the head holder are positioned to brace an animal's neck at a top and bottom thereof, respectively.

FIG. 1B is another front elevational view of the prior art livestock head holder of FIG. 1A, but in a fully opened state thereof with the top and bottom holding members pivotally raised and lowered from their closed positions to near-vertical open positions.

FIG. 2 is a front elevational view of an improved livestock head holder of the present invention in the fully open state thereof in which gravitational dropping of the top holding member of the head holder is prevented by an over-centered locking position of a connecting link between the top and bottom holding members.

FIG. 3 is another front elevational view of the head holder of FIG. 2, but shown part way into a closing stroke thereof, at a point in which the intermediate link has crossed through a center position to release the over-center locking action on the top holding member.

FIG. 4A is another front elevational view of the head holder of FIG. 3 upon completion of the closing stroke to achieve a closed state of the head holder.

FIG. 4B is a cross-sectional view of the head holder of FIG. 4A from the same viewing plane, but cross-sectioned to reveal otherwise hidden componentry thereof.

FIG. 5 is a front perspective view of the head holder of FIG. 2 installed on one gate panel of a head gate.

FIG. 6 is a rear perspective view of the head holder and gate panel of FIG. 5.

FIG. 7 is a closeup partial enlargement of the head holder and gate panel of FIG. 5.

FIG. 8 is a closeup partial enlargement of the head holder and gate panel of FIG. 6.

FIG. 9 is a rear perspective view of the head holder of FIG. 6, but shown in isolation from the gate panel.

FIG. 10 is a front elevational view of the head holder of FIG. 4 in an installed state thereof on a full head gate.

In the drawings like characters of reference indicate corresponding parts in the different figures.

### DETAILED DESCRIPTION

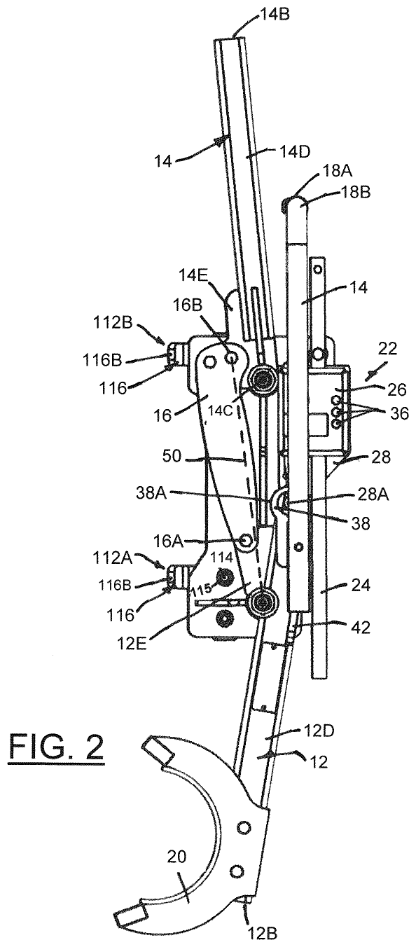

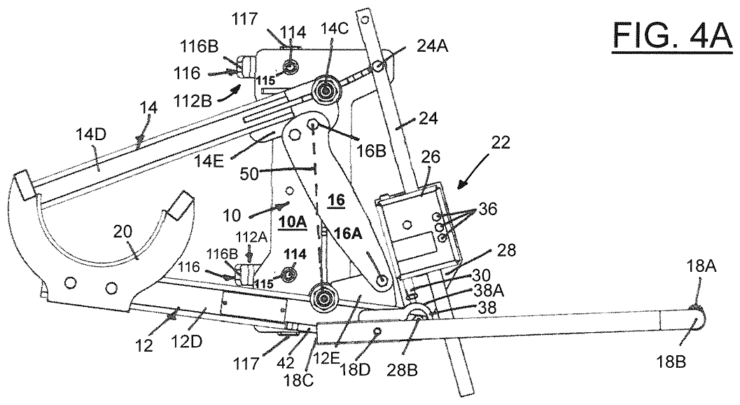

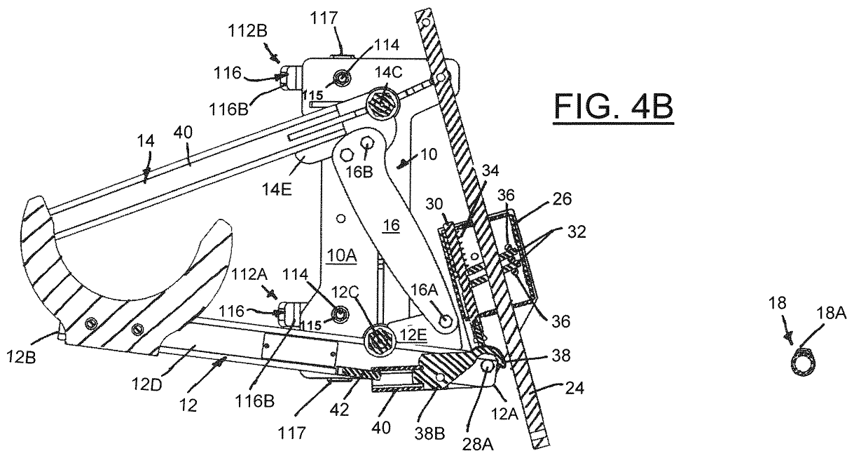

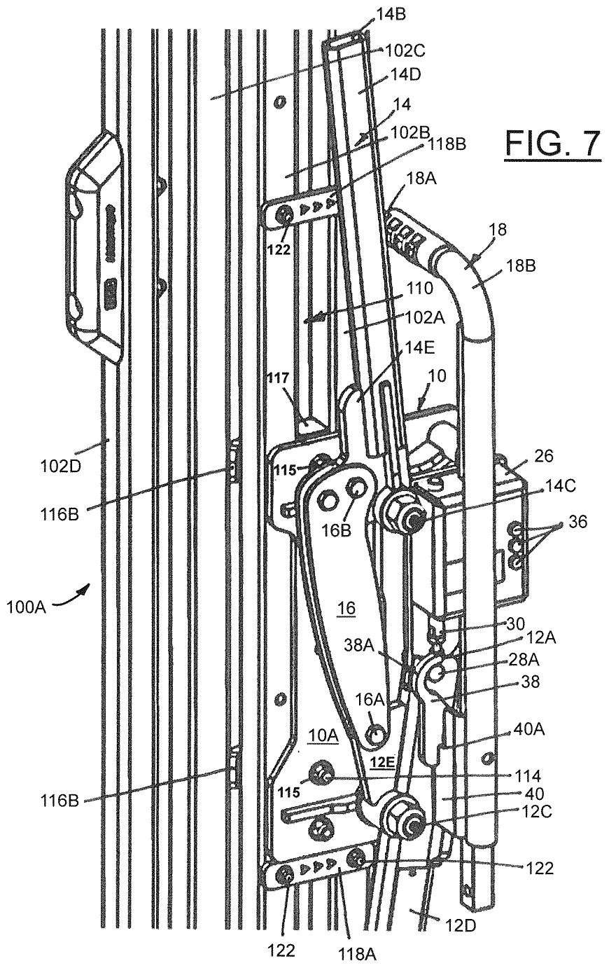

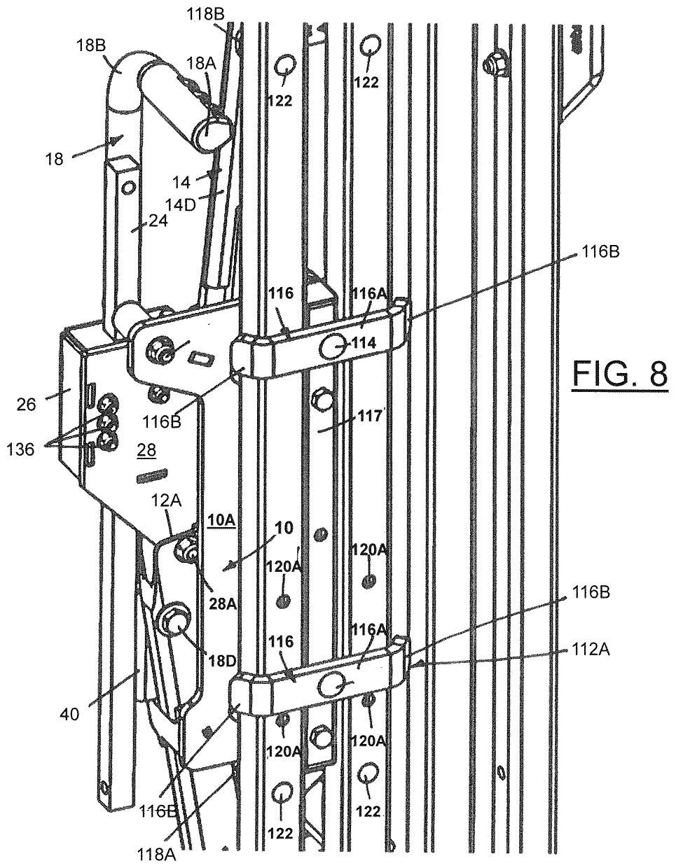

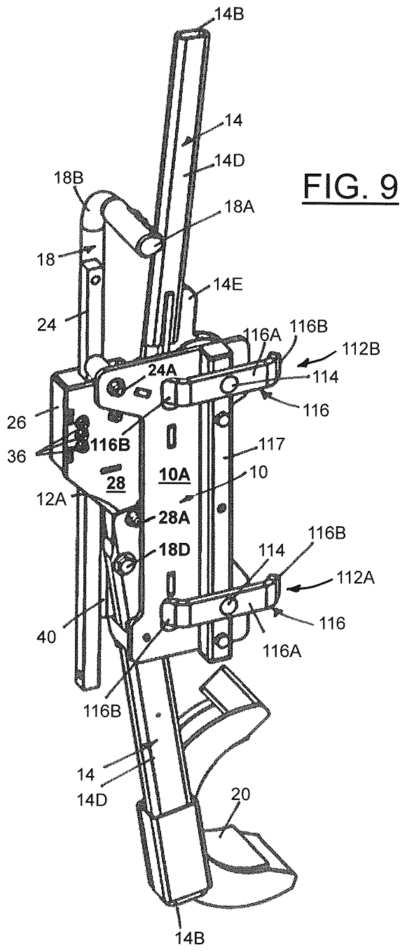

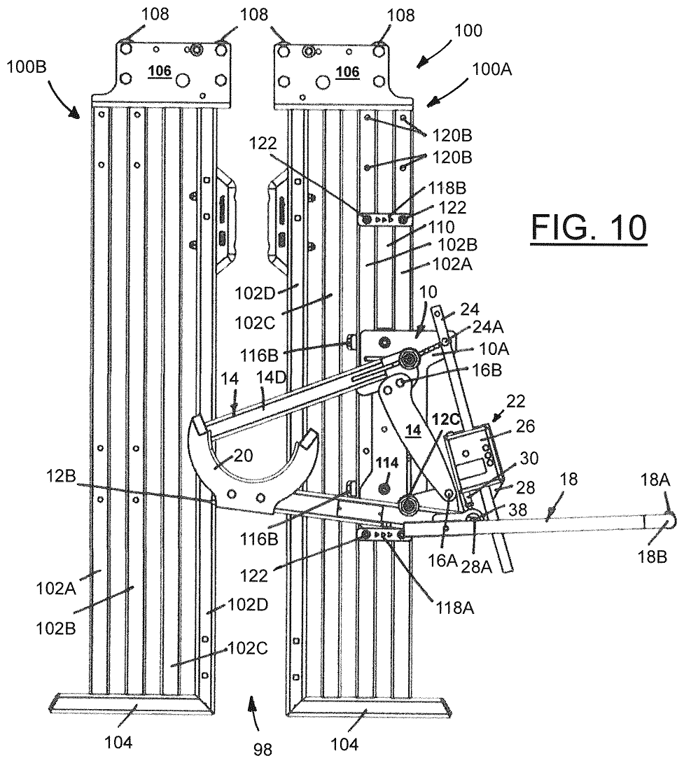

FIG. 2 illustrates a livestock head holder apparatus of the present invention, which like the prior art features a frame 10, for example embodied substantially, if not entirely, by a flat steel plate 10A, and a linkage that is movably supported on the frame 10, and includes a bottom holding member 12 pivotably coupled to the frame 10, a top holding member 14 pivotably coupled to the frame 10, and an intermediate link 16 pivotably coupled to both holding members 12, 14. The top holding member 14 has a first end 14A and an opposing second working end 14B. Near its first end 14A, the top holding member 14 is pivotally coupled to the frame 10 near an upper end thereof by a respective pivot pin 14C. The bottom holding member 12 also has a first end 12A (visible in FIGS. 4B and 7-9) and an opposing second working end 12B. Near its first end 12A, the bottom holding member 12 is pivotally coupled to the frame 10 near a lower end thereof by a respective pivot pin 12C. A U-shaped neck cradle 20 is affixed to the bottom holding member 12 near the working end 12B thereof. Both holding members 12, 14 are pivotally pinned to the frame 10 at a front side thereof by their respective pivot pins, and in the closed state of FIGS. 4A, 4B and 10, both holding members 12, 14 span laterally outward from one side of the frame 10 in a common direction so that the neck cradle 20 of the bottom holding member resides below the top holding member 14 near the working end 14B thereof in an orientation opening upwardly theretoward. Accordingly, in the closed state of the head holder, the top holding member 14 and the neck cradle 20 of the bottom holding member 12 brace against the topside and underside of the animal's neck to restrain and stabilize the animal's head in the same manner as the prior art apparatus referenced in the background above.

The intermediate link 16 has its lower end pivotally coupled to the bottom holding member 12 by lower pivot pin 16A at a location between the pivot pin 12C and first end 12A of the bottom holding member. The upper end of the intermediate link 16 is pivotally coupled to the top holding member 14 by an upper pivot pin 16B at a location between the top holding member's pivot pin 14C and working end 14B, but closer to the pivot pin 14C and the first end 14A than to the working end 14B. Connected to the two holding members 12, 14 in this fashion, the intermediate link 16 will cause the top holding member 14 to automatically swing in an opposite direction to the bottom holding member 12 when the bottom holding member 12 is swung about its respective pivot pin 12C via an operating lever 18 coupled to the bottom holding member 12.

As shown, each holding member may be made up of a linear length of square or rectangular metal tubing 12D, 14D and a respective metal bracket 12E, 14E welded or otherwise rigidly affixed to the tubing at suitable locations for the necessary couplings of intermediate link 16 through its pivot pins 16A, 16B. The bracket 14E of top holding member 14 also defines the respective mounting point at which the top holding member 14 is coupled to the frame 10 by the respective pivot pin 14C. The pivot pins 12C, 14C, 16A, 16B that couple the holding members 12, 14 to the frame 10 and couple the intermediate link 16 to the holding members 12, 14 are all oriented horizontally, and lie parallel to one another and perpendicular to the vertical plane of the main plate 10A of the frame 10, whereby these pins 12C, 14C, 16A, 16B enable movement of the linkage within a vertical working plane of parallel and adjacent relation to the main plate 10A of the frame 10.

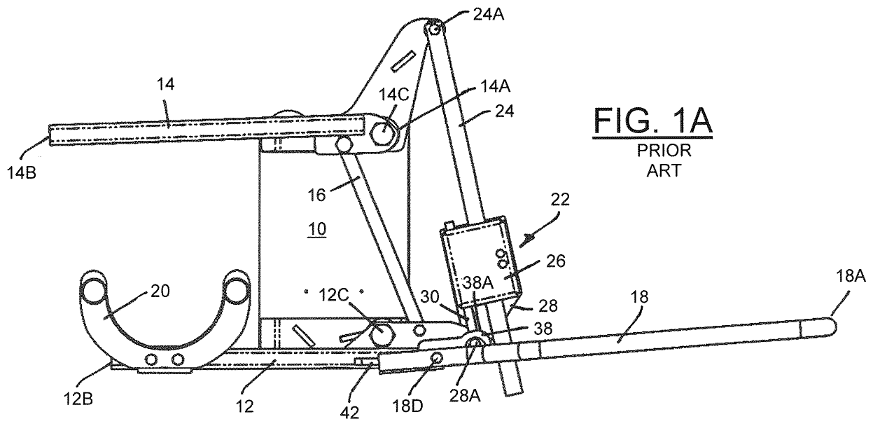

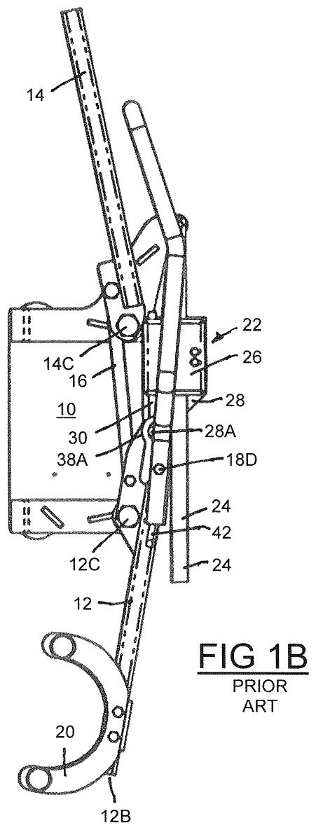

The operating lever 18 is connected to the bottom holding member 12 in a manner reaching outwardly beyond the first end 12A thereof, which in the illustrated example is a slotted end of the tubing 12D that receives the mounting plate 28 of the lock housing 26. The free end 18A of the operating lever 18 forms a handle for manual actuation of the linkage movement via the lever 18. The operating lever 18 of the illustrated embodiment is pivotally connected to the bottom holding member 12 in similar manner as the prior art head holder of FIGS. 1A and 1B to allow a small degree of pivotal movement relative thereto, and as shown, may include a perpendicular bend 18B near the free end 18A to enable comfortable gripping of a handle-like end region of the lever 18 from different operator stances. Like that of the illustrated prior art, the lock and release mechanism 22 once again features a shaft 24, a lock housing 26 carried on a mounting plate 28, a release pin 30, and inside the lock housing 26, one or more tiltable locking plates 32 biased into a tilted locking position by a spring 34 coiled around the release pin 30. Internal details of the release pin 30 and one or more tiltable lock plates situated inside the lock housing 26 may be the same as described and illustrated in Applicant's '262 patent, but in the illustrated example, vary slightly therefrom, including replacement of round holes in the tiltable locking plates 32 with square or rectangular holes to accommodate a change of the shaft 24 from the round cross-section of the prior art to the square or rectangular cross section of the present embodiment, and optionally constraining each one of two locking plates 32 between a respective adjacent two of three locating pins 36.

The shaft 24 is connected to the frame 10 at or near an upper outer corner thereof by a respective pivot pin 24A lying parallel to the other pivot pins. The shaft 24 hangs downwardly from its pivotal connection at an outer side of the frame 10 that is of opposing relationship to an inner side of the frame from which the holding members 12, 14 laterally extend in the closed state of the head holder. The mounting plate 28 and attached lock housing 26 are pivotally connected to the bottom holding member 12 adjacent the first end 12A thereof by another pivot pin 28A lying parallel to the other pivot pins. The lock housing 26 and mounting plate 28 thus cooperatively form a lock carrier by which the locking components in the housing are pivotally carried on the bottom holding member 12. However, it will be appreciated that this carrier need not necessarily employ a fully enclosed housing.

The release pin 30 is linear in shape and protrudes from a bottom wall of the lock housing 26 so that a bottom actuation end of the release pin 30 resides outside the lock housing 26 at a position therebeneath. The shaft 24 passes fully through the lock housing 26 via suitably sized openings in opposing top and bottom walls thereof at a position between the release pin 30 and an outer sidewall of the lock housing 26. At an intermediate location between the top and bottom walls of the lock housing 26, the set of three aforementioned locating pins 36 span horizontally through the mounting plate 28 and an opposing front wall of the lock housing 26 in a direction perpendicular to the shaft 24 and parallel to all the pivot pins of the linkage. Inside the lock housing 26, each tiltable locking plate 32 has one end thereof constrained between an adjacent pair of the locating pins 36. The locating pins and respective end of the lock plate reside on an outer side of the shaft 24 opposite that on which the release pin 30, holding members 12, 14 and intermediate link 16 reside. On the opposing inner side of the shaft 24, a second end of each locking plate 32 features a notch through which the release pin 30 passes on its path of downward projection through the lock housing 26. Where it passes through the notch in each locking plate 32, the release pin 30 has a reduced-diameter portion defining a circumferential recess therearound, where the notched-out end of the locking plate 32 engages with the release pin 30. The width of the notch in the locking plate 32 is equal to, or slightly exceeds, the reduced diameter of the recessed portion 30b of the release pin, but is less than the full-diameter portions of the release pin 30 that remain intact above and below each locking plate 32. Accordingly, upward and downward displacement of the pin 30 forces the notched end of each locking plate 32 upward and downward relative to the first end of the locking plate that is constrained between the locating pins 36, as the shouldered transitions between the reduced-diameter and full diameter portions of the release pin 30 abut against the lock plate at the intact areas on either side of the notch to force the notched end up and down during axial displacement of the release pin in opposing directions.

Between the first end of each locking plate 32 and the notched-out second end thereof, the aforementioned square or rectangular opening in the locking plate accommodates passage of the shaft 24 therethrough. The opening is of slightly greater measure than the cross-sectional size of the shaft 24, so that when the locking plate lies perpendicular to the shaft, the shaft is freely slidable through the locking plate. A compression spring 34 is coiled around the release pin 30 between the top one of the locking plates 32 and the top wall of the lock housing 26, and therefore normally forces the notched-out pin-engaging end of each locking plate 32 downwardly, thereby tilting the locking plate 32 into a non-perpendicular orientation relative to the shaft 24. The degree of tilt and the size of the opening in each locking plate are such that the perimeter edge of each lock plate opening bites against the outer periphery of the shaft 24, thereby locking the shaft against downward axial displacement relative to the lock housing 26 and the locking plate 28 attached thereto. Such downward displacement of the shaft 24 relative to the lock housing corresponds to movement of the head holder linkage in the opening direction, and so the locking action effected by the lock and release mechanism 22 is referred to herein as an anti-opening locking action. The spring 34 normally tilts each locking plate 32 into its locking position, but upward axial displacement of the release pin 30 into a raised position forces the notched end of each locking plate 32 upwardly, thus pivoting the locking plate 32 about its constrained first end out of its tilted locking position into the release position perpendicular to the shaft 24, whereupon opening movement of the head holder linkage is permitted.

To cause upward driving of the release pin 30 into its raised position overcoming the spring force to pivot the locking plate into its release position, a cam member 38 is carried on the operating lever 18 at or near its movable connection to the bottom holding member 12 via pivot pin 18D. A topside of the cam member 38 features an upwardly convex camming surface 38A that resides beneath the lower actuation end of release pin 30 at a distance below the bottom wall of the lock housing 26. This way, the lower actuation end 30A of the release pin 30 can abut against this camming surface 38A and travel therealong. The convex camming surface 38A is defined atop an arc-shaped end portion of the camming member 38, whose opposing concave underside bridges over the pivot pin 28A of the lock-carrying mounting plate 28. From the arc-shaped portion, a remaining leg 38B of the cam member 38 extends in one direction away from the shaft 24 alongside the bottom holding member 12 toward the working end 12B thereof, as best shown in the cross-sectional view of FIG. 4B.

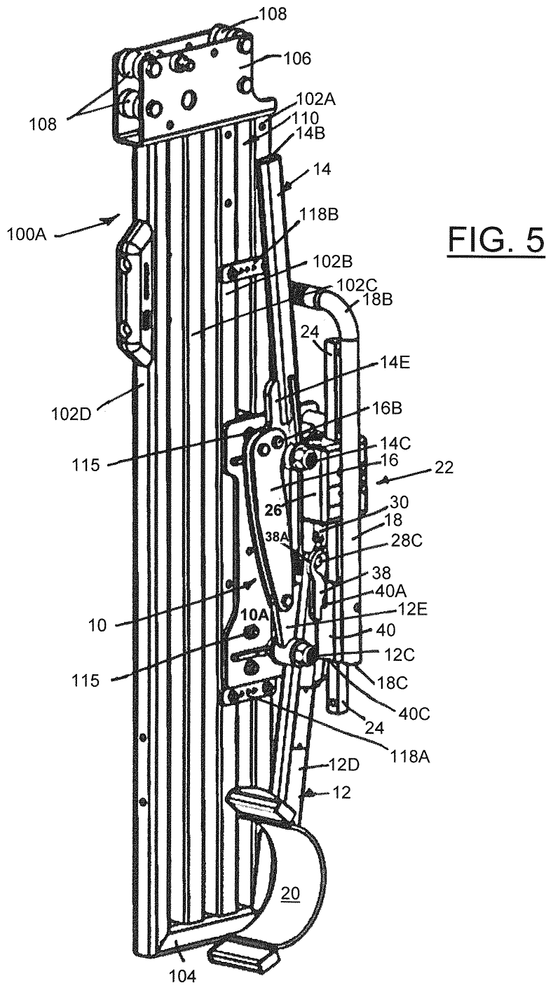

The leg 38B of the cam member reaches into an end slot 40A in the top and bottom walls of a hollow tubular member 40 at one end thereof, which slot 40A can be seen in FIG. 5, and inside the hollow tubular member 40, is of notably greater width than the opposing arc-shaped end of the camming member 38. The tubular member 40 is affixed, for example welded, to the operating lever 18 at a working end 18C thereof opposite the manually operated free end 18A thereof, and at a rear side of the lever 18 that faces toward the bottom holding member 12. The slotted end of the tubular member 40 faces toward the free end 18A of the operating lever 18, so that the slotted end faces toward the shaft 24 in the closed state of the head holder.

The movable connection between the operating handle 18 and the bottom holding member 12 is provided by a respective pivot pin 18D that lies parallel to the other pivot pins and passes through at least a rear wall of the hollow tubular member 40, if not also through a front wall thereof and the operating lever 18 itself, and through the widened part of the camming member 38 inside the hollow tubular member, as well as through the bottom holding member 12, or at least a front wall thereof. An L-shaped stop tab 42 protruding from the bottom holding member 12 has a first leg jutting perpendicularly out from the front side of the bottom holding member, and a second leg reaching along the bottom holding member 12 toward the first end 12A thereof. The stop tab 42 is located near the bottom holding member's pivot pin 12C so as to be on the side of the operating lever pivot pin 18D opposite the first end 12A of the bottom holding member 12, and thus opposite the shaft 24 and release pin 30 in the closed state of the head holder. The distance from the operating lever's pivot pin 18D to the nearest end of the second leg of the stop tab is less the distance from the operating lever's pivot pin 18D to the unslotted distal end 40C of the tubular member 40. Accordingly, with the tubular member 40 pinned to the front side of the bottom holding member 12, the second leg of the stop tab 42 reaches into the opening at the distal end 40C of the hollow tubular member 40. The thickness of the stop tab 42 is less than the height of the tubular member 40, whereby the tubular member 40 and the operating lever 18 affixed thereto can pivot a limited degree relative to the bottom holding member 12 about the pivot pin 18D.

In the closed state of the head holder, the weight of the operating lever 18 will tend to lower the free end 18A thereof until the stop tab 42 abuts the topside of the tubular member's bottom wall, thus defining a default position of the operating lever relative to the bottom holding member 12 in the closed state of the head holder. In this position, the cam member 38 carried on the operating lever 18 by the tubular member 40 has its cam surface 38A in non-forceful contact with, or spaced relation from, the lower actuation end of the release pin 30. With the apparatus in the closed state, initial lifting of the operating lever 18 will tilt the free end 18A upwardly relative to the bottom holding member 12, and the limited degree of tilting between the operating lever 18 and the bottom holding member 12 occurs before the top wall of the tubular member 40 abuts against the stop tab 42 (as shown in FIGS. 4A and 4B), and this limited degree of tilting is sufficient to force the camming surface 38A upwardly against the lower actuation end 30 of the release pin 30, and thereby lift the release pin 30 into a raised position forcing the locking plates 32 into their untilted release position perpendicular to the shaft 24. Until this release of the anti-opening locking action takes place, upward lifting of the first end 12A of the bottom holding member 12 (as required to lower the opposing working end 12B thereof about pivot pin 12C) is not possible, as the lock housing 26 carried on the bottom working member 12 by mounting plate 28 cannot move upwardly because the tilted locking position of the locking plates 32 in the lock housing 26 prevents relative sliding of the lock housing 26 along the shaft 24.

However, once the operating handle 18 reaches its predetermined limit of upward tilting relative to the bottom holding member 12, and thereby releases the anti-opening locking action on the shaft 24, the first end 12A of the bottom holding member 12 can now rise under continued lifting of the operating lever 18. So as the top wall of the tubular member 40 lowers into contact with the stop tab 42, denoting the limit of its initial tilting movement, the first end 12A of the bottom holding member 12 will be lifted upwardly about the pivot pin 12C with the operating lever 18. So continued lifting of the operating lever 18 lifts the first end 12A of the bottom holding member 12 along with it, which lowers the working end 12B of the bottom holding member 12 downwardly about pivot pin 12C and thereby performs the opening stroke of the linkage to withdraw the two holding members 12, 14 away from one another and release the animal. During this opening stroke, the convexly curved camming surface 38A of the cam member 38 maintains the release pin 30 in its raised position holding the locking plates 32 perpendicular to the shaft 24 to allow continued travel of the lock housing 26 along the shaft 24 due to the free sliding relationship between the shaft and the lock plates lying perpendicularly thereof. Accordingly, this allows continued lowering of the working end 12B of the bottom holding member 12, which in turn causes the working end 14B of the top holding member to rise under the action of the intermediate link 16 connected between the two holding members.

FIG. 2 shows the head holder in its fully opened state, where the top holding member 14 stands generally upright in a near vertical orientation, and the bottom holding member 12 hangs downward in a near vertical orientation, and the bottom actuating end of the release pin 30 has reached the terminal end of the camming surface 38A at the tip of the arc-shaped cam end of the cam member 38. From this, it will be appreciated that the cam member 38, through continuous contact with the lower actuation end of the release pin 30, maintains the unlocked state of the lock/release mechanism 22 throughout the full opening stroke of the linkage. From the fully opened state of FIG. 2, re-closing of the apparatus simply requires manual grasping of the free end 18A of the operating lever and pulling thereof away from the top holding member 14 and downwardly toward the ground. The tilted locking position of the lock plates 32 places the top perimeter edge of each lock plate's opening into biting engagement with the shaft 24, where attempted upward displacement of the lock housing 26 along the shaft 24 only increases the biting action of the lock plates 32 on the shaft 24, thereby increasing the anti-opening locking force to prevent any movement. On the other hand, during the closing stroke, where the lock housing 26 is forced downwardly along the shaft 24, relative sliding between the shaft 24 and the biting edges of the locking plates is allowed to occur. Accordingly, no lock-release action is required to enable the closing stroke.

Thus far, the foregoing description of the head holder is relatively consistent with that of the prior art design from Applicant's '262 patent, with minor variation, for the purpose of setting one non-limiting example of an operating context for inventive aspects of the present invention, to which attention is now turned. That said, the inventive aspects of the present invention may also be employed on a head holder whose lock and release mechanism 22 is differently configured, and not necessarily released via actuation of the same operating lever 18 by which the opening and closing strokes of the linkage are driven. For example, the inventive aspects of the present invention may alternatively be employed in the context of the even earlier prior art described in the background of Applicant's '262 patent, where the lock housing and mounting plate are pivotally pinned to the frame near the upper outer corner thereof, whose shaft is pivotally pinned to the bottom holding member near the first end thereof, and whose release pin is an L-shaped pin whose bent top end resides outside and above the lock housing and is manually lifted to release the anti-opening locking action of one or more tiltable lock plates on the shaft inside the lock housing, thus requiring two-handed operation to open the head holder: one hand to lift the release pin, and one hand to lift the operating lever 18.

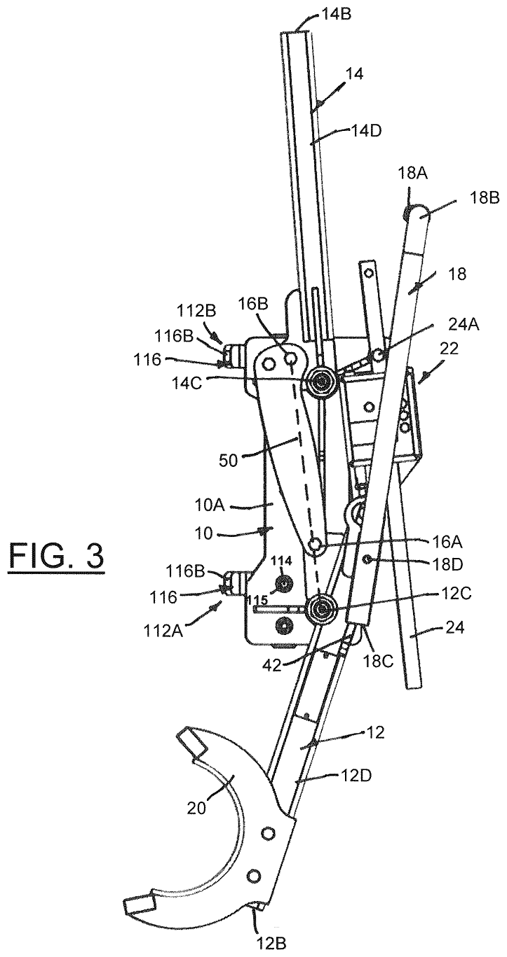

A first and significant differentiator of the present invention over the prior art of FIGS. 1A and 1B is now described with particular reference to FIGS. 2 and 3, which illustrate a novel over-center locking action exerted on the top holding member 14 by an over-centered locking position of the intermediate link 16 in the fully open state of the head holder. This over-center locking action is effective to prevent any possible gravity-induced dropping of the top holding member 14 from its fully raised upright position shown in FIG. 2. The over-center position of the intermediate link 16 is described in relation to an imaginary reference line 50 that spans from the pivot axis of the pivot pin 12C of the bottom holding member 12 to the pivot axis of the upper pivot pin 16B of the intermediate link. In the over-centered locking position of intermediate link, the lower pivot pin 16A of the intermediate link 16 resides on a first side of the imaginary reference line 50, specifically on an inner side thereof of opposing relation to an outer side thereof at which the lock and release mechanism 22 resides. This inner side of the imaginary reference line 50 is a same side thereof that corresponds to the openable/closeable center 98 of a head gate 100 on which the head holder resides in use (shown in FIG. 10). The pivot pin 14C of the top holding member 14 resides on the opposing outer side of the imaginary reference line 50. In the fully open state of the head holder, the upper pivot pin 16B of the intermediate link 16 resides radially outward from an upper inner quadrant of the pivot pin 14C of the top holding member 14.

Lowering of the top holding member 14 from its fully raised position of FIG. 2 thus requires arcing movement of the intermediate link's upper pivot pin 16B downwardly and inwardly about the axis of the top holding member's pivot pin 14C, which in turn would require synchronous arcing movement of the intermediate link's lower pivot pin 16A downwardly and outwardly about the bottom holding member's pivot pin 12C, but such movement is blocked as a result of an over-centered position of the intermediate link's lower pivot pin 16A relative to a centered position thereof in which it would instead reside coincident with the imaginary reference line 50, and thus inline with, or centered between, pivot pins 16B and 12C. In the over-centered locking position of the intermediate link 16 (FIG. 2), gravitational downforce on the top holding member 14, or any other force applied thereto in a direction corresponding to a downward swinging of the top holding member 14, is incapable of causing such downward swinging. Downward movement of the top holding member 14 is only enabled by an intentional outward swinging of the intermediate link's bottom end to move the lower pivot pin 16A through its center point, i.e. through the imaginary reference line 50 to the outer side thereof, thus reorienting the intermediate link 16 out of its over-centered locking position. FIG. 3 shows the head holder during an initial phase of the closing stroke, where the lower pivot point 16A has just crossed its centered position coincident with the imaginary reference line 50, and now resides on the opposing outer side thereof, thus releasing the over-center locking action on the top holding member 14.

In practice of the illustrated embodiment, this withdrawal of the intermediate link 16 from its over-centered locking position is typically achieved by manual exertion of a closing actuation force at the handle-defining free end 18A of the operating lever 18, i.e. an outward pulling of free end 18A of the operating lever 18 in a direction corresponding to closing movement of the head holder linkage. Such user actuation of the operating handle in the closing direction swings the first end 12A of the bottom holding member downwardly about pivot pin 12C, thereby pulling the intermediate link's lower pivot pin 16A outwardly across the imaginary reference line, and thus through its center point between pivot pins 12C, 16B, thereby withdrawing the intermediate link from its over-centered locking position.

In the illustrated embodiment, the operating lever 18 is thus singularly operable to open and close the head holder, to release the anti-opening locking action imparted by the lock and release mechanism 22 during initial lifting of the lever 18 in the closed state of the head holder, and to also release the over-center locking action of the over-centered intermediate link 16 during initial outward pulling of the lever 18 in the fully opened state of the head holder. That being said, the same novel use of an over-centered position of a link 16 in the head holder linkage to impart an over-center locking action on the top holding member 14 of the head holder in the fully open state thereof may be put to similar use, regardless of whether it is in the context of a single-lever operating design like that of illustrated embodiment, or in the context of another design where release of the over-center locking action and/or the anti-opening locking action is exerted by one or more actuation components other than a manually operated lever 18 that is used to open and close the head holder.

Another novel distinction of the present invention over the prior art is in the mounting componentry by which the head holder is mounted to a head gate 100 in height adjustable fashion, particularly in a manner that provides a greater and more tuneable degree to which the head holder can be adjusted in its installed height on the head gate 100. To illustrate the use of this mounting componentry, FIGS. 5 to 8 show the head holder installed on one of two gate panels of a livestock head gate, and FIG. 10 shows the head holder in the operating context of the two gate panels 100A, 100B of the full livestock head gate 100. This illustrated head gate 100 is of a type used at exits of at least some of Applicant's commercially available squeeze chutes, other details of which are omitted, given lack of relevancy to the details of the present invention.

In the illustrated example, each gate panel 100A, 100B of the headgate 100 is of a skeletal construction composed of a plurality of upright bars 102A-102D standing vertically upright from a horizontally oriented bottom bar 104, and a channel-shaped roller support bracket 106 that is installed atop the upright bars 102A-102D to carry a set of rollers 108 that enable rolling support of the gate panel on an overhead support track (not shown) that is likewise shared by the other gate panel. Of the upright bars 102A-102D, of which there are four in the non-limiting example of the illustrated embodiment, an outside bar 102A of each gate panel 100A, 100B refers to that which resides at an outer side of the gate panel furthest from the other gate panel, an inside bar 102D of each gate panel 100A, 100B refers to that which resides nearest to the other gate panel, outside-adjacent bar 102B refers to a second outermost bar of adjacent relationship to the outside bar 102A, and inside-adjacent bar 102C refers to a second innermost bar of adjacent relationship to the inside bar 102D, and thus also of adjacent relationship to the outside-adjacent bar 102B in the illustrated four-bar embodiment. Each pair of adjacent bars are horizontally separated from one another along the bottom bar 104, thus leaving a vertical slot 110 between each pair of adjacent bars. The mounting of the head holder to the head gate makes use of such a vertical slot 110, and in the non-limiting example of the illustrated embodiment, particularly makes use of the vertical slot 110 between the outside bar 102A and outside-adjacent bar 102B of the gate panel 100A.

The head holder is supported on the gate panel 100A by two clamps 112A, 112B, each of which features a threaded bolt fastener 114 whose shaft passes through a bolt hole in the main plate 10A of the frame 10 and is fitted with a securement nut 115 at a front side of the plate 10A. Each clamp 112A, 112B also features a backing member 116 that is carried on the shaft of the bolt fastener 114 in a position rearwardly behind the main plate 10A of the frame 10 and in front of the head of the bolt fastener 114. The backing member 116 of the illustrated example is a bent rectangular plate that, in its working position clamped to the head gate, lies horizontally perpendicular to the shaft of the bolt fastener 114 and radiates outwardly therefrom at laterally opposing sides thereof. The backing member 116 has a central span 116A residing in a plane of orthogonal relationship to the shaft of the bolt fastener 114 to radiate therefrom at the laterally opposing sides thereof. At the two horizontally opposing ends of this central span 116A, the backing member 116 is bent, thereby forming forwardly angled end segments 116B of the backing member 116 that diverge forwardly from the central span 116A, each preferably at an oblique angle thereto of greater than 90-degrees, but less than 180-degrees, for example between twenty and sixty degrees, more particularly between thirty and fifty degrees in some instances, and even more particularly between thirty-five and forty-five degrees in the illustrated example.

In the installed condition of the head holder on the gate panel 100A of the head gate 100, the rear side of the main plate 10A of the frame 10 is abutted against the front side of the outside and outside-adjacent bars 102A, 102B of the gate panel 100A, and the bolt fasteners 114 project rearwardly from the main plate 10A of the frame 10 through the vertical slot 110 between those two bars 102A, 102B of the gate panel. The bolt fasteners 114 carry the two backing members 116 immediately behind the two bars 102A, 102B, in forcefully clamped relationship against the rear sides thereof, which is achieved by an installer-tightening of the two securements nuts 115 at the front side of the frame's main plate 10A. The two clamps 112A, 112B thereby secure the head holder to the gate panel 100A via clamped embrace of the two backing members 116 against the rear side of the gate panel 100A of the head gate 100. A horizontal width of the flat central span 116A of the backing member 116, from one bend of the backing member 116 to the other, is roughly equal to a combined horizontal width of the two adjacent bars 102A, 102B of the gate panel 100A and the vertical slot 110 therebetween, so that these two bends respectively engage the two outer rear corners of the adjacent bars 102A, 102B, i.e. the respective rear corners thereof furthest from the slot 110 between the two bars 102A, 102B. The forwardly angled end segments 116B of the backing member 116 thus hook forwardly about the two bars 102A, 102B at the outer sides thereof furthest from the slot 110, thus providing a tighter, more biting, secure engagement of the backing member 116 with the bars 102A, 102B than would be achieved with a purely flat backing member 116 abutted in only flush relation against the rear sides of the bars 102A, 102B of the gate panel 100A.

This clamped mounting of the head holder to the gate panel 100A enables infinitely fine-tunable height adjustment of the head holder's clamped position on the head gate 100 at any elevation thereon selectable at the installer's or user's discretion, as the clamps 112A, 112B are in no way fixed or constrained to any particular elevation thereof on the gate panel 100A, and thus can be tightened at any selected location along the vertical slot 110 between the two bars 102A, 102B. Adjustment of the selected elevation is easily enabled by a mere loosening of the securement nuts 115, followed by lifting or lowering of the frame 10 to a newly desired elevation, at which the securement nuts 115 are then retightened to regain the securely clamped condition of the frame 10 onto the gate panel 100A.

For optimal alignment of the head holder on the gate panel 100A, an alignment guide 117 is bolted or otherwise attached to the main plate 10A of the frame 10 on the rear side thereof, and runs vertically of the frame 10 in perpendicular relation to horizontal top and bottom edges of the main plate 10A. The alignment guide 117 has a width of equal or very slightly lesser measure than the width of the vertical slot 110 between the two adjacent bars 102A, 102B of the gate panel 100A. The two bolt fasteners 114 of the clamps 112 reside in aligned relation to this alignment guide 117, and in the illustrated example, penetrate through the alignment guide 117, which as shown, may be an elongated bar, for example composed of a length of square or rectangular tubing, of which the gate panel bars 102A-102D are also composed in the illustrated example. During installation of the head holder, insertion of this alignment guide 117 into the vertical slot 110 of the gate panel 100A achieves proper alignment of the head holder on the gate panel 100A, and retains such alignment during elevational adjustment and clamping of the head holder at its selected mounting height. Instead of a singular alignment guide 117 of notable vertical measure, multiple alignment guides of lesser vertical measure may alternatively be employed for similar purpose, for example with a lower alignment guide through which the bolt fastener 114 of the lower clamp 112A may extend, a separate upper alignment guide through the bolt fastener 114 of the upper clamp 112B may extend.

There may be absolute upper and lower limits on the fractional span of the overall height of the head gate 100 within which the head holder can be mounted for practical use. For example, below a certain mounting height of the frame 10 of the head holder on the gate panel 100A, full opening of the head holder would be prevented by impact of the bottom holding member 12 with the ground, thus dictating an absolute lower limit on an available height adjustment range for the head holder. Similarly, there may be an absolute upper limit on the height adjustment range, for example dictated by presence of manufacturer-branded signage or other equipment possibly situated overhead of the head holder that would prevent full raising of the top holding member 14 of the head holder if mounted above this absolute upper limit. For practical purposes, an installer or user may wish to further limit the available height adjustment range, for example based on anticipated minimum and/or maximum sizes of animal that the user is anticipated to work with the equipment.

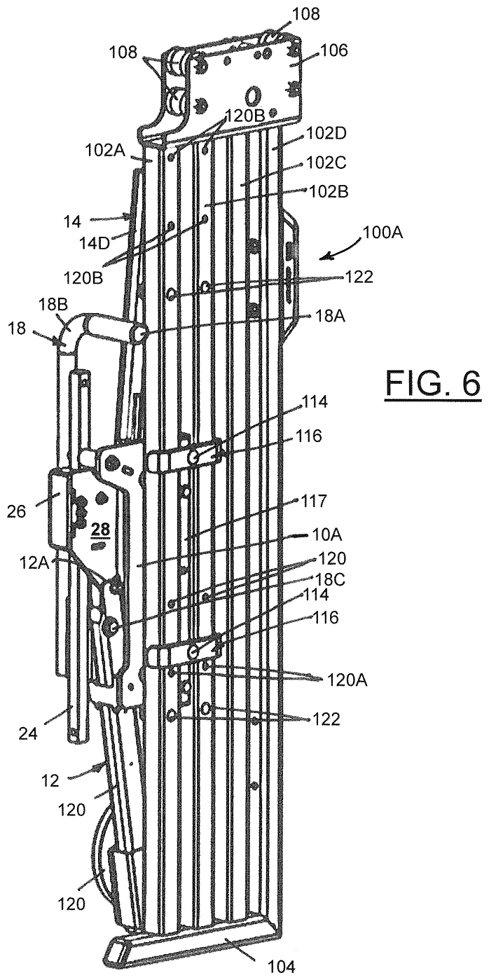

For the purpose of setting such absolute or practical limits on the available height adjustability range of the head holder, the illustrated embodiment includes a lower stop bar 118A, and an upper stop bar 118B, each of which is selectively fastenable to the two adjacent bars 102A, 102B of the gate panel 100A at any one of a respective plurality of user-selectable stop elevations, at each of which the two adjacent bars 102A, 102B are characterized by presence of a respective pair of bolt holes 120A, 120B therein. With reference to the rear view of the gate panel 100A in FIG. 6, there are three lower pairs of bolt holes 120A available for selective mounting of the lower stop bar 118A at any one pair of these three lower pairs of bolt holes 120A, and three upper pairs of bolt holes 120B available for selective mounting of the upper stop bar 118B at any one pair of these three upper pairs of bolts 120B. The lower stop bar 118A is shown mounted to the lowermost pair of three lower pairs of bolt holes 120A, which denotes the absolute lower limit on the height adjustability range for the head holder frame 10, below which the head holder would no longer be able to fully open with a safe degree of ground clearance. At installer or user discretion, the lower stop bar 118A may be moved up to either one of other two lower pairs of bolts holes 120A at higher elevation, for example based on an anticipated minimum size of animal the user would anticipate working with the equipment.

The lower and upper stop bars 118A, 118B are bolted to the front of the adjacent bars 102A, 102B of the gate panel 100A, for example using bolts 122 that are fed through the bars 102A, 102B from the rear sides thereof, and are then fitted with nuts in front of the stop bars 118A, 118B. The resulting limits on the height adjustability range are imparted by physical contact of a bottom edge of the main plate 10A of the head holder frame 10 with the lower stop bar 118A at the lower limit of the available height adjustability range, and physical contact of a top edge of the main plate 10A of the head holder frame 10 with the upper stop bar 118B at the upper limit of the available height adjustability range. For this reason, a thickness of each stop bar 118A, 118B is preferably at least as thick as the main plate 10A of the head holder frame 10, for example being made of an equal or thicker gauge of metal plating or metal bar stock, though other shapes and material compositions may be used to similar effect. The lower stop bar 118A also serves as a resting shelf atop which the frame 10 of the head holder may be temporarily rested during initial installation, and during any subsequent height adjustment, of the head holder.

Since various modifications can be made in my invention as herein above described, and many apparently widely different embodiments of same made within the scope of the claims without departure from such scope, it is intended that all matter contained in the accompanying specification shall be interpreted as illustrative only and not in a limiting sense.

1. The livestock head holder of claim 2 further comprising:
an intermediate link (16) pivotally coupled to the top holding member at a third pivot point (16B) and pivotally coupled to the bottom holding member at a fourth pivot point (16A) to coordinate movement of the top and bottom holding members during opening and closing of the head holder between the closed state in which the top and bottom holding members occupy laterally oriented positions spanning in a common lateral direction from the frame to brace a top and bottom of an animal's neck, respectively, from one side thereof, and the fully open state in which the top and bottom holding members are of pivotally raised and lowered relation, respectively, to the laterally oriented positions occupied thereby in the closed state;
wherein, relative to an imaginary reference line (50) spanning from the second pivot point (12C) to the third pivot point, the fourth pivot point (16A) resides on a first side of said imaginary reference line in the fully open state of the head holder in an over-center position that effects the over-center locking action on the top holding member to prevent gravitational dropping thereof, and said fourth pivot point is movable, via exertion of a closing actuation force on the linkage, from said over-center position, through a center-position of coincident relation to said imaginary reference line, and onward to an opposing second side of said imaginary reference line, thereby releasing said over-center locking action.

2. A livestock head holder comprising:
a frame (10); and
a linkage comprising:
a top holding member (14) pivotally coupled to the frame at a first pivot point;
a bottom holding member (12) pivotally coupled to the frame at a second pivot point;
wherein said linkage is configured to effect an over-center locking action on the top holding member in a fully open state of the linkage to prevent gravitational dropping of said top holding member in said fully open state, and said over-center locking action is releasable by input of a closing actuation force on said linkage to initiate movement thereof toward a closed state.

3. The livestock head holder of claim 2 wherein the linkage further comprises an operating lever that is coupled to the bottom holding member, and actuatable to impart said closing actuation force to the linkage.

4. The livestock head holder of a claim 2 comprising a lock and release mechanism arranged to impart an anti-opening locking action on the linkage that prevents movement from the closed state thereof to the opening state thereof in absence of a lock-release input to said lock and release mechanism.

5. The livestock head holder of claim 3 comprising a lock and release mechanism arranged to impart an anti-opening locking action on the linkage that prevents movement from the closed state thereof to the opening state thereof in absence of a lock-release input to said lock and release mechanism, wherein said operating lever is configured to provide said lock-release input to said lock and release mechanism during an initial lifting of said operating lever to initiate an opening stroke driving movement of the linkage from the closed state to the fully open state.

6-21. (canceled)
